(19) United States
(12) Patent Application Publication
(10) Pub. No.: US 2010/0018810 A1
(43) Pub. Date: Jan. 28, 2010

(54) ELEVATOR APPARATUS

(75) Inventors: Takashi Yumura, Tokyo (JP); Takaharu Ueda, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: MITSUBISHI ELECTRIC CORPORATION, Tokyo (JP)

(21) Appl. No.: 11/722,728

(22) PCT Filed: Feb. 17, 2006
(86) PCT No.: PCT/JP06/02832

§ 371 Date: Jun. 25, 2007

(30) Foreign Application Priority Data
Mar. 1, 2005 (JP) 2005-055906

(51) Int. Cl. B66B 11/08

(52) U.S. Cl. 187/258; 187/251

(57) ABSTRACT

In an elevator apparatus, a car and a counterweight are raised/lowered by hoisting machines. Each of those hoisting machines includes a drive sheave and a hoisting machine body, the hoisting machine body including an electric motor for rotating the drive sheave and a hoisting machine brake for braking rotation of the drive sheave. At least one of the car and the counterweight includes a raised/lowered body-mounted brake device for stopping the car as an emergency measure on a condition different from a condition set for a safety gear.

### TECHNICAL FIELD

The present invention relates to an elevator apparatus employing a plurality of hoisting machines to raise/lower a single car.

### BACKGROUND ART

In recent years, there have been demands for an elevator capable of transporting more passengers more speedily along with constructions of high-rise buildings. For satisfying such demands, enlargement of a car is conceivable as one method. To attain the enhancement of the car, however, a large-size hoisting machine with large torque and a large output is required, so the costs of manufacture, lifting/setup, and the like increase.

On the other hand, there has been proposed an elevator apparatus employing two hoisting machines to raise/lower a single car instead of increasing the size of a single hoisting machine. In this elevator apparatus, the car and a counterweight are provided with fall blocks, respectively, to eliminate an inconvenience ascribable to a difference in speed generated between the two hoisting machines (e.g., see Patent Document 1).

Patent Document 1: JP 0742063 A

### DISCLOSURE OF THE INVENTION

### Problems to be Solved by the Invention

In the conventional elevator apparatus constructed as described above, the car and the counterweight are provided with the fall blocks, respectively, so an endless rope is required as a main rope. However, the endless rope is manufactured by connecting both ends of a single rope to each other, so it is difficult to eliminate a step at a joint of both the ends of the rope. Further, there is an individual difference in operation timing or braking force between brakes provided on the two hoisting machines, so the difference between the running distances of the main rope made by two drive sheaves increases at the time of an emergency stop. In consequence, the joint moves past the drive sheaves and the fall blocks due to a shift in the position of the rope, so the car may develop vibrations.

The present invention has been made to solve the above-mentioned problems, and it is therefore an object of the present invention to provide an elevator apparatus capable of ensuring a stable stop with a small amount of shift in the position of a rope even at the time of emergency braking while employing a plurality of hoisting machines.

### Means for Solving the Problems

An elevator apparatus according to the present invention includes: a plurality of hoisting machines having drive sheaves and hoisting machine bodies, respectively, the hoisting machine bodies including electric motors for rotating the drive sheaves, respectively, and hoisting machine brakes for braking rotation of the drive sheaves; at least one main rope wound around the drive sheaves; a car and a counterweight that are suspended by the main rope to be raised/lowered by the hoisting machines; a safety gear for stopping the car as an emergency measure when a speed of the car reaches a preset overspeed; and a raised/lowered body-mounted brake device, mounted on at least one of the car and the counterweight, for stopping the car as an emergency measure on a condition different from a condition set for the safety gear.

Further, an elevator apparatus according to the present invention includes: a plurality of hoisting machines having drive sheaves and hoisting machine bodies, respectively, the hoisting machine bodies including electric motors for rotating the drive sheaves, respectively, and hoisting machine brakes for braking rotation of the drive sheaves; at least one main rope wound around the drive sheaves; a car and a counterweight that are suspended by the main rope to be raised/lowered by the hoisting machines; and a rope brake device for applying a braking force to the main rope to stop the car as an emergency measure.

Still further, an elevator apparatus according to the present invention includes: a plurality of hoisting machines having drive sheaves and hoisting machine bodies, respectively, the hoisting machine bodies including electric motors for rotating the drive sheaves, respectively, and hoisting machine brakes for braking rotation of the drive sheaves; at least one main rope wound around the drive sheaves; a car and a counterweight that are suspended by the main rope to be raised/lowered by the hoisting machines; and a brake safety circuit for monitoring operating states of the hoisting machine brakes and causing, when one of the hoisting machine brakes performs a braking operation, the other hoisting machine brakes to perform braking operations as well.

Yet further, in an elevator apparatus according to the present invention: a plurality of hoisting machines is employed to move a single car; neither of the hoisting machines has a brake; and at least one of the car serving as a raised/lowered body and another raised/lowered body have brakes.

### BRIEF DESCRIPTION OF THE DRAWINGS

FIG. 1 is a perspective view showing an elevator apparatus according to Embodiment 1 of the present invention.

FIG. 2 is a perspective view showing an elevator apparatus according to Embodiment 2 of the present invention.

FIG. 3 is a perspective view showing an elevator apparatus according to Embodiment 3 of the present invention.

FIG. 4 is a perspective view showing an elevator apparatus according to Embodiment 4 of the present invention.

FIG. 5 is a perspective view showing an elevator apparatus according to Embodiment 5 of the present invention.

FIG. 6 is a wiring diagram showing a first wiring example of hoisting machine brakes of FIG. 5.

FIG. 7 is a wiring diagram showing a second wiring example of the hoisting machine brakes of FIG. 5.

FIG. 8 is a wiring diagram showing a third wiring example of the hoisting machine brakes of FIG. 5.

### BEST MODES FOR CARRYING OUT THE INVENTION

Best modes for carrying out the present invention will be described hereinafter with reference to the drawings.

### Embodiment 1

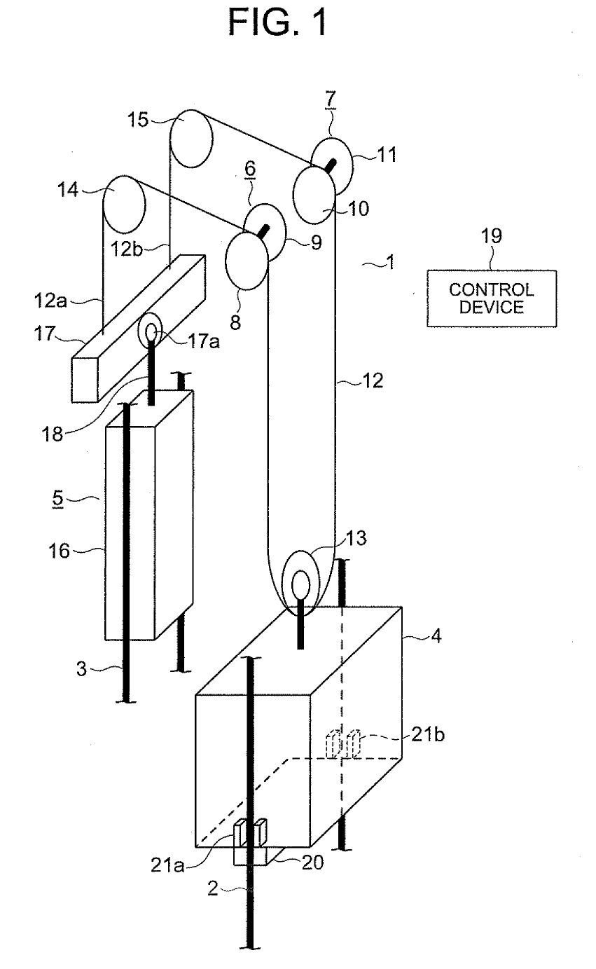

FIG. 1 is a perspective view showing an elevator apparatus according to Embodiment 1 of the present invention. Referring to FIG. 1, a pair of car guide rails 2 and a pair of counterweight guide rails 3 are installed within a hoistway 1. A car 4 serving as a first raised/lowered body is raised/lowered within the hoistway 1 along the car guide rails 2. A counterweight 5 serving as a second raised/lowered body is raised/lowered within the hoistway 1 along the counterweight guide rails 3.

The counterweight 5 has a counterweight body 16 serving as a raised/lowered main body, a rocking member (rope connection member) 17 rockably connected to the counterweight body 16, and a connection member 18 for connecting the counterweight body 16 and the rocking member 17 to each other. The counterweight body 16 is suspended from the rocking member 17 via the connection member 18.

The connection member 18 is turnably coupled at an upper end thereof to a rocking center of the rocking member 17, namely, a rocking shaft 17a. The rocking shaft 17a extends horizontally and parallel to a thickness direction of the counterweight body 16. The connection member 18 is connected at a lower end thereof to the center of an upper portion of the counterweight body 16. The connection member 18 is provided at the upper end thereof with rocking detecting means (not shown) for detecting a rocking state of the rocking member 17. Employed as the rocking detecting means is, for example, an encoder.

A first hoisting machine 6 and a second hoisting machine 7 are disposed in an upper portion of the hoistway 1. The first hoisting machine 6 has a first drive sheave 8 and a first hoisting machine body 9. The first hoisting machine body 9 includes a first electric motor for rotating the first drive sheave 8, and a first hoisting machine brake for braking rotation of the first drive sheave 8.

The second hoisting machine 7 has a second drive sheave 10 and a second hoisting machine body 11. The second hoisting machine body 11 includes a second electric motor for rotating the second drive sheave 10, and a second hoisting machine brake for braking rotation of the second drive sheave 10. The first hoisting machine 6 and the second hoisting machine 7 are disposed such that rotary shafts of the drive sheaves 8 and 10 extend horizontally.

At least one main rope 12 is wound around the first drive sheave 8 and the second drive sheave 10. The car 4 and the counterweight 5, which are suspended within the hoistway 1 by means of the main rope 12, are raised/lowered within the hoistway 1 due to driving forces of the first hoisting machine 6 and the second hoisting machine 7. The counterweight 5 is raised/lowered in the direction opposite to the car 4.

The main rope 12 has a first rope end 12a connected to the rocking member 17 on one side of the rocking shaft 17a of the rocking member 17, and a second rope end 12b connected to the rocking member 17 on the other side of the rocking shaft 17a. The first rope end 12a and the second rope end 12b are connected to the rocking member 17 at positions equidistant from the rocking shaft 17a.

A first deflector pulley 14 for leading the first rope end 12a to the counterweight 5 and a second deflector pulley 15 for leading the second rope end 12b to the counterweight 5 are disposed in the upper portion of the hoistway 1. The first deflector pulley 14 and the second deflector pulley 15 are disposed such that rotary shafts thereof extend horizontally.

A balance pulley 13 rotatable around a horizontal rotary shaft is provided above the car 4. An intermediate portion of the main rope 12 is wound around the balance pulley 13.

The first hoisting machine 6 and the second hoisting machine 7 are controlled by a control device 19. In response to a signal from the rocking detecting means, the control device 19 controls the first hoisting machine 6 and the second hoisting machine 7 so as to counterbalance the rocking of the rocking member 17, namely, to return the rocking member 17 to a horizontal state.

A safety gear 20 for stopping the car 4 as an emergency measure when the speed of the car 4 reaches a preset overspeed (e.g., time and four-tenths of a rated speed) is mounted on a lower portion of the car 4.

The car 4 is also mounted with a pair of car-mounted brake devices 21a and 21b as raised/lowered body-mounted brake devices for stopping the car 4 as an emergency measure on a condition different from a condition set for the safety gear 20. The car-mounted brake devices 21a and 21b grip the car guide rails 2 to brake the car 4. Employed as the car-mounted brake devices 21a and 21b are, for example, electromagnetic brake devices.

A terminal slowdown device and an overrun limiting device are provided in the vicinity of each of an uppermost floor and a lowermost floor within the hoistway 1. As a result, the car 4 is usually decelerated and stopped according to a preset speed curve in the vicinity of each of the uppermost floor and the lowermost floor within the hoistway 1. However, when the speed of the car 4 deviates from the speed curve for some reason, a safety circuit within the control device 19 is shut off, and an emergency stop command is output from the control device 19. As a result, the car 4 is forcibly stopped as an emergency measure by the car-mounted brake devices 21a and 21b independently of the first hoisting machine brake and the second hoisting machine brake.

In the elevator apparatus constructed as described above, the first hoisting machine 6 and the second hoisting machine 7 are controlled by the control device 19 so as to be operated in synchronization with each other. However, owing to a manufacturing error between the drive sheaves 8 and 10, a minor slippage caused between each of the drive sheaves 8 and 10 and the main rope 12 at the time of acceleration/deceleration, braking, or the like of the car 4, fluctuations in the torques of the hoisting machine bodies 9 and 11, and the like, a minor error is generated between the running distance of the main rope 12 on the first drive sheave 8 side with respect to the car 4 and the running distance of the main rope 12 on the second drive sheave 10 side with respect to the car 4. This minor error between the running distances is absorbed through the rocking (inclination) of the rocking member 17, which serves as a scale-type balance mechanism.

However, if there is a difference in operation timing or braking force when the hoisting machine brakes are operated in an emergency, a major error is generated in a short period of time between the running distance of the main rope 12 on the drive sheave 8 side and the running distance of the main rope 12 on the drive sheave 10 side and may not be completely absorbed by the scale-type balance mechanism. In an emergency, therefore, instead of operating the first hoisting machine brake and the second hoisting machine brake, only the car-mounted brake devices 21a and 21b are operated to forcibly stop the car 4 as an emergency measure. In this manner, there is no difference between the distance by which the main rope 12 is raised/lowered and the distance by which the car 4 is raised/lowered even when the car 4 is braked. As a result, the car 4 can be stopped stably. In particular, if the pair of the car-mounted brake devices 21a and 21b are mechanically interlocked with each other, it is possible to operate the car-mounted brake devices 21a and 21b more reliably at the same time.

The construction of each of the car-mounted brake devices 21a and 21b may be partially shared by the safety gear 20.

In an emergency, the first hoisting machine brake and the second hoisting machine brake may be used in addition to the car-mounted brake devices 21a and 21b. In this case, it is preferable to adopt a sequence circuitry designed such that the hoisting machine brakes are operated after the car-mounted brake devices 21a and 21b have been operated.

It is also appropriate to construct a system without the hoisting machine brakes, namely, exclusively with the car-mounted brake devices 21a and 21b, and use the car-mounted brake devices 21a and 21b in braking the car 4 at the time of a normal stop thereof at each floor as well. In this case, the hoisting machine brakes are omitted, so the number of parts is reduced. As a result, a simplification of the system and a cost reduction can be achieved.

The number of the hoisting machines for driving should not be limited to two. For example, additional hoisting machines may be disposed at the positions of the deflector pulleys 14 and 15.

### Embodiment 2

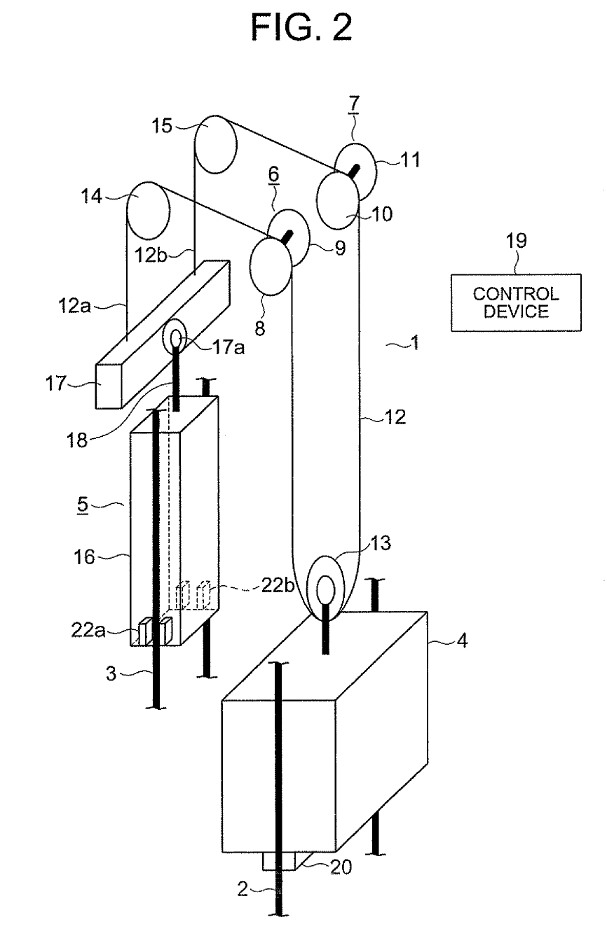

Reference will be made next to FIG. 2. FIG. 2 is a perspective view showing an elevator apparatus according to Embodiment 2 of the present invention. Referring to FIG. 2, the counterweight 5 is mounted with a pair of counterweight-mounted brake devices 22a and 22b serving as raised/lowered body-mounted brake devices for stopping the car 4 as an emergency measure on a condition different from the condition set for the safety gear 20. The counterweight-mounted brake devices 22a and 22b grip the counterweight guide rails 3 to brake the counterweight 5, thereby braking the car 4. Embodiment 2 of the present invention is identical to Embodiment 1 of the present invention in other constructional details.

In the elevator apparatus constructed as described above, the car 4 is forcibly stopped as an emergency measure by the counterweight-mounted brake devices 22a and 22b independently of the first hoisting machine brake and the second hoisting machine brake in an emergency. Therefore, the difference between the running distance of the main rope 12 on the drive sheave 8 side and the running distance of the main rope 12 on the drive sheave 10 side is prevented from increasing due to a difference between braking forces of the hoisting machine brakes. That is, the stopping distance of the car 4 can be more stably controlled independently of the hoisting machine brakes. In particular, if the pair of the counterweight-mounted brake devices 22a and 22b are mechanically interlocked with each other, it is possible to operate the counterweight-mounted brake devices 22a and 22b more reliably at the same time.

With the employment of the counterweight-mounted brake devices 22a and 22b, vibrations or noise resulting from an emergency braking operation are unlikely to be transmitted to the inside of the car 4.

### Embodiment 3

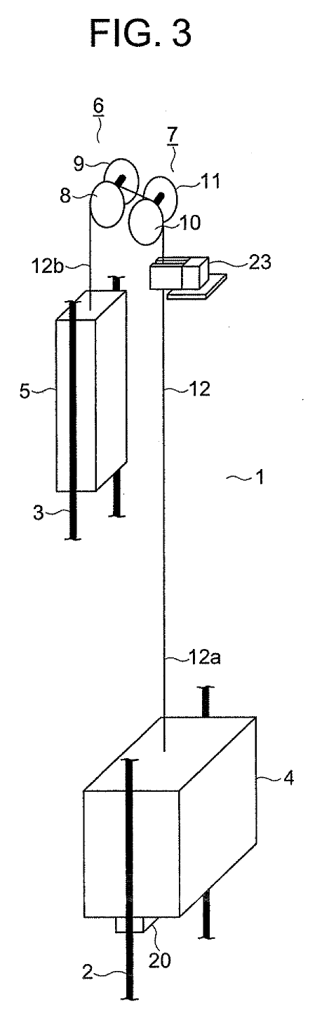

Reference will be made next to FIG. 3. FIG. 3 is a perspective view showing an elevator apparatus according to Embodiment 3 of the present invention. In this example, the car 4 and the counterweight 5 are suspended according to a simple 1:1 roping arrangement without employing a balance pulley or a rocking member. That is, the first rope end 12a of each of the main ropes 12 is connected to an upper portion of the car 4, and the second rope end 12b of each of the main ropes 12 is connected to an upper portion of the counterweight 5.

The first hoisting machine 6 and the second hoisting machine 7 are disposed side by side such that each of the main ropes 12 moves past the first drive sheave 8 and the second drive sheave 10 in succession. That is, the first drive sheave 8 and the second drive sheave 10 are disposed radially offset from each other.

A rope brake device 23 for applying a braking force to each of the main ropes 12 to stop the car 4 as an emergency measure is installed in the upper portion of the hoistway 1 (within a machine room or the hoistway 1). The rope brake device 23 grips all the main ropes 12 at the same time to brake the movement thereof, thereby braking the car 4.

In the elevator apparatus constructed as described above, the car 4 is forcibly stopped as an emergency measure by the rope brake device 23 independently of the first hoisting machine brake and the second hoisting machine brake in an emergency. Therefore, the difference between the running distance of each of the main ropes 12 on the drive sheave 8 side and the running distance of each of the main ropes 12 on the drive sheave 10 side is prevented from increasing due to a difference between braking forces of the hoisting machine brakes. That is, the stopping distance of the car 4 can be more stably controlled independently of the hoisting machine brakes.

The main ropes 12 are gripped at the time of emergency braking, so the drive sheaves 8 and 10 idly rotate with respect to the main ropes 12 even in the unlikely event that the hoisting machines 6 and 7 fail to be stopped. As a result, the car 4 can be stopped more reliably.

### Embodiment 4

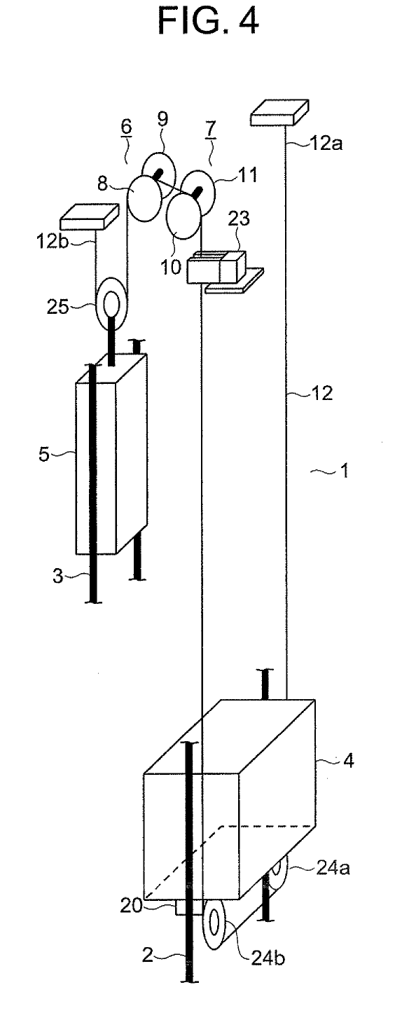

Reference will be made next to FIG. 4. FIG. 4 is a perspective view showing an elevator apparatus according to Embodiment 4 of the present invention. In this example, the car 4 and the counterweight 5 are suspended according to a 2:1 roping arrangement. That is, a pair of car suspending pulleys 24a and 24b are mounted on the lower portion of the car 4. A counterweight suspending pulley 25 is mounted on the upper portion of the counterweight 5. The first rope end 12a of each of the main ropes 12 and the second rope end 12b of each of the main ropes 12 are connected to the upper portion of the hoistway 1. Each of the main ropes 12 is looped, from the first rope end 12a side thereof, around the car suspending pulleys 24a and 24b, the second drive sheave 10, the first drive sheave 8, and the counterweight suspending pulley 25 in the stated order. Embodiment 4 of the present invention is identical to Embodiment 3 of the present invention in other constructional details.

In the elevator apparatus constructed as described above according to the 2:1 roping arrangement as well, the car 4 is forcibly stopped as an emergency measure by the rope brake device 23 independently of the first hoisting machine brake and the second hoisting machine brake in an emergency. Therefore, the difference between the running distance of each of the main ropes 12 on the drive sheave 8 side and the running distance of each of the main ropes 12 on the drive sheave 10 side is prevented from increasing due to a difference between braking forces of the hoisting machine brakes. That is, the stopping distance of the car 4 can be more stably controlled independently of the hoisting machine brakes.

In an emergency, the first hoisting machine brake and the second hoisting machine brake may be used in addition to the rope brake device 23. In this case, it is preferable to adopt a sequence circuitry designed such that the hoisting machine brakes are operated after the rope brake device 23 has been operated.

### Embodiment 5

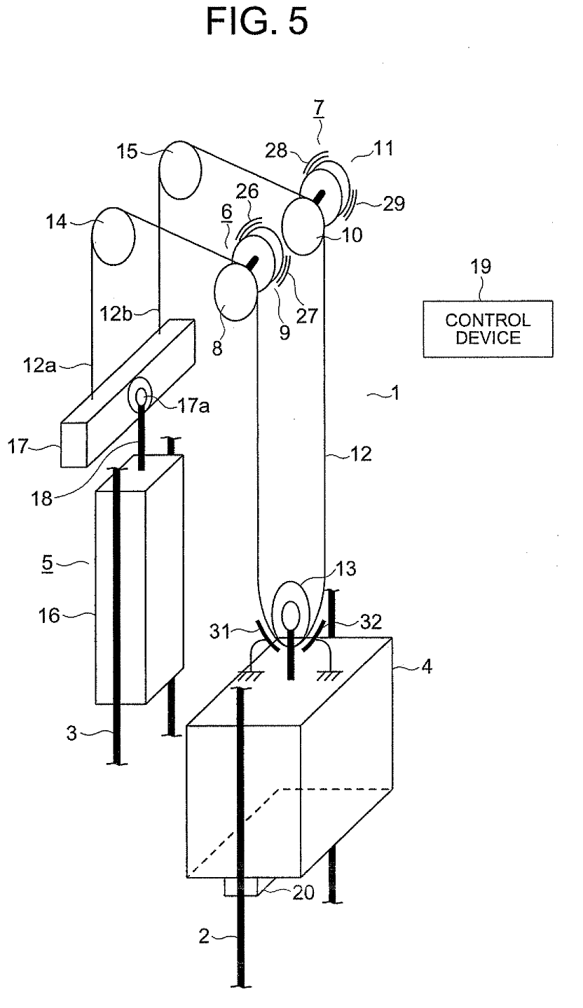

Reference will be made next to FIG. 5. FIG. 5 is a perspective view showing an elevator apparatus according to Embodiment 5 of the present invention. The first hoisting machine 6 is provided with two first hoisting machine brakes 26 and 27. The second hoisting machine 7 is provided with two second hoisting machine brakes 28 and 29.

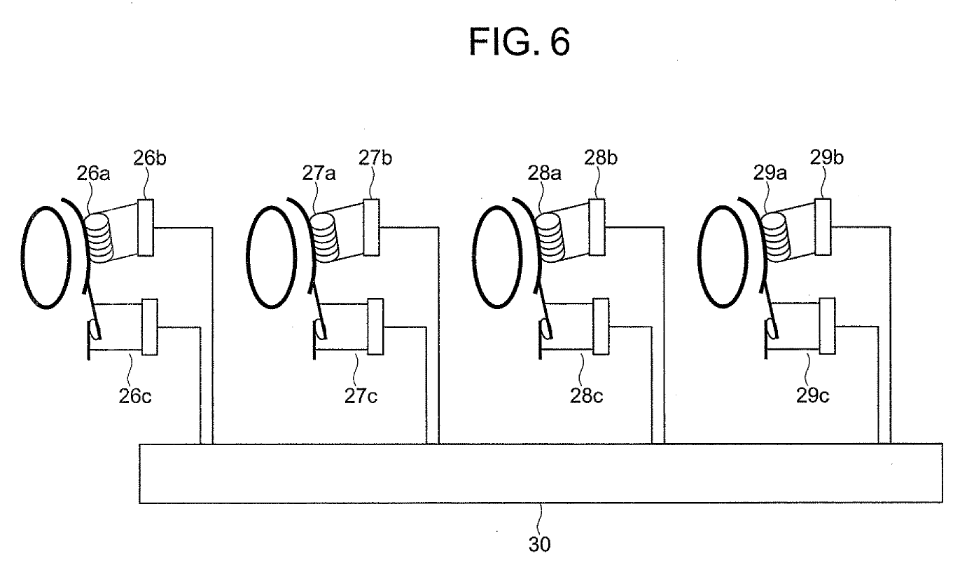

FIG. 6 is a wiring diagram of the hoisting machine brakes 26 to 29 of FIG. 5. The hoisting machine brakes 26 to 29 are electromagnetic brakes for energizing brake coils 26a, 27a, 28a, and 29a to cancel braking forces, respectively, and suspending the energization of the brake coils 26a, 27a, 28a, and 29a to generate braking forces, respectively. The hoisting machine brakes 26 to 29 are respectively provided with energization monitoring portions (energization monitoring circuits) 26b, 27b, 28b, and 29b for monitoring energization states of the brake coils 26a, 27a, 28a, and 29a, respectively.

In addition, the hoisting machine brakes 26 to 29 are respectively provided with operation monitoring portions (operation monitoring circuits) 26c, 27c, 28c, and 29c for monitoring operating positions of brake shoes, respectively. The operation monitoring portions 26c, 27c, 28c, and 29c are respectively provided with micro switches that are opened through braking operations of the brake shoes, respectively.

All the energization monitoring portions 26b, 27b, 28b, and 29b and all the operation monitoring portions 26c, 27c, 28c, and 29c are connected to a brake safety circuit 30. The brake safety circuit 30 monitors operating states of the first hoisting machine brakes 26 and 27 and the second hoisting machine brakes 28 and 29. When one of the first hoisting machine brakes 26 and 27 and the second hoisting machine brakes 28 and 29 performs a braking operation, the brake safety circuit 30 causes the other hoisting machine brakes to perform braking operations as well. More specifically, when even one of the energization monitoring portions 26b, 27b, 28b, and 29b and the operation monitoring portions 26c, 27c, 28c, and 29c detects a braking operation, the brake safety circuit 30 causes all the hoisting machine brakes 26 to 29 to perform braking operations, respectively.

The brake safety circuit 30 is connected in series to an elevator safety circuit of the control device 19. When the elevator safety circuit is shut off due to an abnormality in an elevator system or the like, the brake safety circuit 30 causes all the hoisting machine brakes 26 to 29 to perform braking operations.

In the elevator apparatus constructed as described above, when one of the first hoisting machine brakes 26 and 27 and the second hoisting machine brakes 28 and 29 performs a braking operation, the single brake safety circuit 30 causes the other hoisting machine brakes to perform braking operations as well. Therefore, the stopping distance of the car 4 at the time of emergency braking can be more stably controlled while employing the plurality of the hoisting machines 6 and 7.

In Embodiment 5 of the present invention, only the operations of the hoisting machine brakes 26 to 29 are monitored by the brake safety circuit 30. However, in employing the car-mounted brake devices 21a and 21b of Embodiment 1 of the present invention, the counterweight-mounted brake devices 22a and 22b of Embodiment 2 of the present invention, the rope brake device 23 of Embodiment 3 or 4 of the present invention, or the like, it is appropriate to monitor those components and interlock the braking operations thereof with those of the hoisting machine brakes 26 to 29.

As shown in FIG. 5, the balance pulley 13 may be provided with balance pulley brakes 31 and 32. In this case, it is appropriate to monitor the operations of the balance pulley brakes 31 and 32 by means of the brake safety circuit 30 and interlock the braking operations of the balance pulley brakes 31 and 32 with those of the other brakes. The balance pulley brakes 31 and 32 may also be designed to hold down and brake the main rope 12 from a fixed side thereof instead of stopping rotation of the balance pulley 13. As a result, the main rope 12 can be braked even in a case where the balance pulley 13 has no traction ability. Moreover, balance pulley brakes can also be added in a case where a balance pulley is mounted on the counterweight 5 side.

Further, in the example of FIG. 6, when even one of the energization monitoring portions 26b, 27b, 28b, and 29b and the operation monitoring portions 26c, 27c, 28c, and 29c detects a braking operation, the brake safety circuit 30 causes all the hoisting machine brakes 26 to 29 to perform braking operations, respectively. In this case, the braking force of at least one of the hoisting machine brakes 26 to 29 may be controlled by the brake safety circuit 30 or a corresponding one of the operation monitoring portions 26c, 27c, 28c, and 29c. That is, the braking force may be reduced to prevent the deceleration of the car 4 from becoming excessively large. As a result, the car 4 can be decelerated and stopped without suffering an excess impact, regardless of the load balance between the car 4 and the counterweight 5.

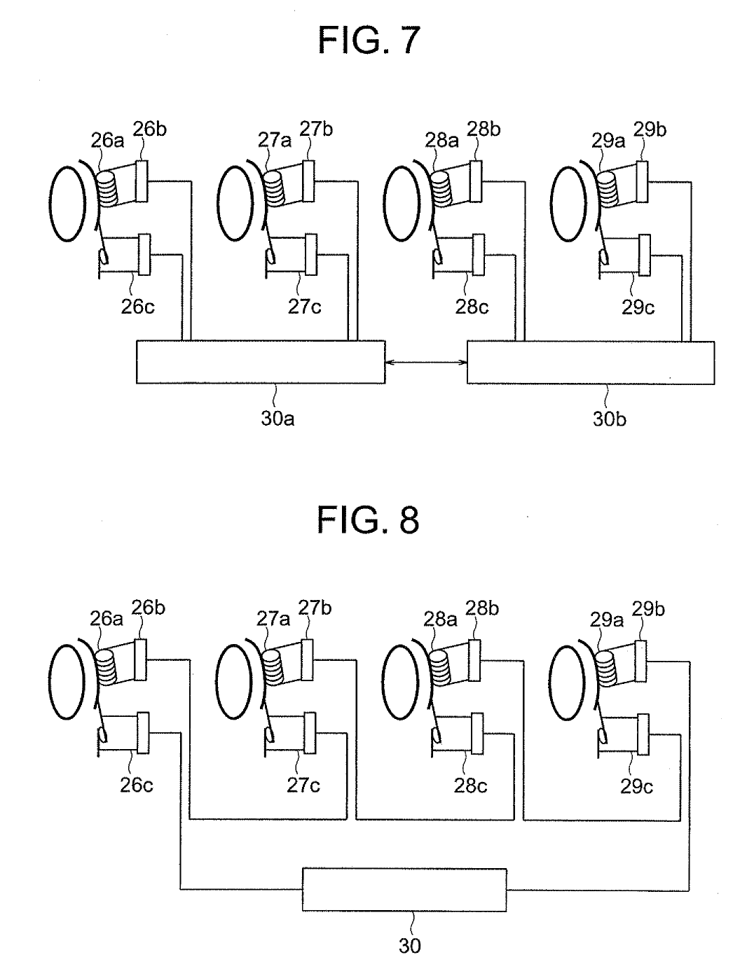

Still further, brake safety circuits may be provided separately for the respective hoisting machines 6 and 7. Referring to FIG. 7, for example, a first brake safety circuit 30a corresponding to the first hoisting machine 6 and a second brake safety circuit 30b corresponding to the second hoisting machine 7 are employed. Signals can be exchanged between the first brake safety circuit 30a and the second brake safety circuit 30b.

By configuring the brake safety circuits 30a and 30b separately for the respective hoisting machines 6 and 7 as described above, each of the hoisting machines 6 and 7 can be provided as a unit. As a result, the same specification of hoisting machine can be shared by an elevator apparatus employing a single hoisting machine and an elevator apparatus employing two hoisting machines.

As shown in, for example, FIG. 8, the brake coils 26a, 27a, 28a, and 29a, the energization monitoring portions 26b, 27b, 28b, and 29b, and the operation monitoring portions 26c, 27c, 28c, and 29c may be serially connected as a whole. In this case, when one of the operation monitoring portions 26c, 27c, 28c, and 29c, for example, is shut off due to some abnormality, the circuit of FIG. 8 is shut off, so all the hoisting machine brakes 26 to 29 are forced to perform braking operations. It is therefore possible to configure a failsafe system and hence improve reliability.

Further, as a matter of course, a rope with a circular cross-section or a belt-shaped rope may be employed as the main rope 12.

1. An elevator apparatus comprising:
a plurality of hoisting machines having respective drive sheaves and respective hoisting machine bodies, the hoisting machine bodies including respective electric motors for rotating the drive sheaves, and hoisting machine brakes for braking rotation of the drive sheaves;
at least one main rope wound around the drive sheaves;
a car and a counterweight that are suspended by the main rope and raised and lowered by the hoisting machines;
a safety gear for stopping the car as an emergency measure when speed of the car reaches a preset overspeed; and
an ascending/descending body-mounted brake device, mounted on at least one of the car and the counterweight, for stopping the car as an emergency measure on a condition different from the condition set for the safety gear.

2. The elevator apparatus according to claim 1, wherein the ascending/descending body-mounted brake device is first operated and the hoisting machine brakes are then operated in an emergency stop.

3. An elevator apparatus comprising:
a plurality of hoisting machines having respective drive sheaves and hoisting machine bodies, the hoisting machine bodies including electric motors for rotating the drive sheaves, and hoisting machine brakes for braking rotation of the drive sheaves;
at least one main rope wound around the drive sheaves;
a car and a counterweight that are suspended by the main rope and raised and lowered by the hoisting machines; and
a rope brake device for applying a braking force to the main rope to stop the car as an emergency measure.

4. The elevator apparatus according to claim 3, wherein the rope brake device is first operated and the hoisting machine brakes are then operated in an emergency stop.

5. An elevator apparatus comprising:
a plurality of hoisting machines having respective drive sheaves and respective hoisting machine bodies, the hoisting machine bodies including respective electric motors for rotating the drive sheaves, and hoisting machine brakes for braking rotation of the drive sheaves;
at least one main rope wound around the drive sheaves;
a car and a counterweight that are suspended by the main rope and raised and lowered by the hoisting machines; and
a brake safety circuit for monitoring operating states of the hoisting machine brakes and causing, when one of the hoisting machine brakes performs a braking operation, the other hoisting machine brakes to perform braking operations as well.

6. An elevator apparatus comprising a plurality of hoisting machines to move a single car, wherein:
none of the hoisting machines has a brake; and
at least one of the car, serving as an ascending/descending body, and another ascending/descending body has a brake.
